(19) United States
(12) Patent Application Publication
(10) Pub. No.: US 2005/0220224 A1
(43) Pub. Date: Oct. 6, 2005

(54) Polyphase filter with passband compensation and method therefor

(75) Inventor: Andrew W. Dornbusch, Austin, TX (US)

Correspondence Address: TOLER & LARSON & ABEL L.L.P., 5000 PLAZA ON THE LAKE STE 265, AUSTIN, TX, 78746, US

(73) Assignee: Silicon Laboratories Inc.

(21) Appl. No.: 10/814,615

(22) Filed: Mar. 31, 2004

(51) Int. Cl. H04L 27/22

(52) U.S. Cl. 375/324; 375/326

(57) ABSTRACT

A polyphase filter (320) includes first (340) and second (360) filter sections and a buffer section (350). The first filter section (340) has an input for receiving signals representative of at least two phases of an input signal, and an output for providing signals representative of at least two phases of a filtered signal, and has a first passband response. The buffer section (350) has an input coupled to the output of the first filter section (340), and an output. The second filter section (360) has an input coupled to the output of the buffer (350), and an output for providing an output of the polyphase filter (320), and has a second passband response. The first (340) and second (360) filter sections are configured such that the second passband response compensates for the first passband response.

### TECHNICAL FIELD

The present invention generally relates to electrical filters, and more particularly to polyphase filters.

### BACKGROUND

Radio frequency (RF) receivers are used in a wide variety of applications such as television, cellular telephones, pagers, global positioning system (GPS) receivers, cable modems, cordless phones, satellite radio receivers, and the like. One common type of RF receiver is the so-called superheterodyne receiver. A superheterodyne receiver mixes the desired data-carrying signal with the output of tunable oscillator to produce an output at a fixed intermediate frequency (IF). The fixed IF signal can then be conveniently filtered and converted back down to baseband for further processing. Thus a superheterodyne receiver requires one or more mixing steps.

One well-known problem with the mixing process is that it creates image signals. For some RF systems the level of the image signal is small enough so that designers can rely on the attenuation characteristics of the IF bandpass filter alone to reject image signals. However for other systems the attenuation of the IF bandpass filter is not sufficient. For example satellite radio uses a 2.3 GHz carrier frequency. Each channel has a baseband spectrum from 1 megahertz (MHz) to about 13 MHz, and the adjacent signal spectra can create large image signals. In these systems additional image rejection filtering is required to maintain a sufficient signal-to-noise ratio (SNR) in the desired signal.

One known image signal rejection technique uses a polyphase filter and is performed in two stages. First the input signal is mixed with two separate local oscillator signals that are in quadrature with each other (that is, separated in phase by ninety degrees). Then the two output signals are passed through a phase delay filter to delay the wanted component a certain number of degrees. Then the signals are summed, and the combination of the phase shifts from the mixing process and the phase delay filter causes the desired filter to be passed and its image to be cancelled.

A polyphase filter is a filter that processes more than one phase of an input signal. Polyphase filters have been used occasionally in radio applications for many years, and are useful in single sideband (SSB) applications due to their asymmetric frequency characteristics, which can be used for rejection of the unwanted sideband. However in other radio applications designers typically separate two phases of a signal such as the in-phase (I) and quadrature (Q) components, and process these signals using a single phase filter section before recombining the components into an output signal.

In some contemporary SSB applications, such as satellite radio based on a 2.3 gigahertz (GHz) carrier, the desired signal spectrum is very close to neighboring spectra. Furthermore due to the channel coding the spectrum may have a relatively wide bandwidth. Thus to be useful a polyphase filter needs to have a wide passband yet still retain good selectivity between the desired sideband and the adjacent signal spectrum. Unfortunately single stage polyphase filters have a narrow reject band. To widen the stopband, multiple stages may be cascaded.

However when implemented using passive filters, cascaded polyphase filters have problems with inter-stage loading which results in irregular overall passband responses. Active polyphase filters also possess passband irregularities, albeit to a lesser degree.

### BRIEF SUMMARY

In one form a polyphase filter comprises a first filter section, a buffer section, and a second filter section. The first filter section has an input for receiving signals representative of at least two phases of an input signal, and an output for providing signals representative of at least two phases of a filtered signal, and has a first passband response. The buffer section has an input coupled to the output of the first filter section, and an output. The second filter section has an input coupled to the output of the buffer, and an output for providing an output of the polyphase filter, and has a second passband response. The first and second filter sections are configured such that the second passband response compensates for the first passband response.

In another form a polyphase filter includes at least three polyphase filter stages. A first polyphase filter stage has an input for receiving an input signal. A last polyphase filter stage has an output for providing a filtered signal. Each polyphase filter stage except the first polyphase filter stage has an input coupled to an output of a preceding polyphase filter stage. Each polyphase filter stage except the last polyphase filter stage has an output coupled to an input of a succeeding polyphase filter stage. One of the at least three polyphase filter stages is coupled to another one of the at least three polyphase filter stages by means of a buffer.

In yet another form a method is provided for filtering an input signal to provide a filtered signal. Signals representative of at least two phases of the input signal are formed. The signals are filtered in a polyphase filter having first and second filter sections having respective first and second passband responses. The first filter section has an input for receiving the signals and an output. The second filter section has an input coupled to an output of the first section and an output. The first and second filter sections are configured such that the second passband response compensates for the first passband response. The output of the second filter section is provided as the filtered signal.

In still another form there is provided an image rejecting mixer including first and second multipliers and a polyphase filter. The first multiplier has a first input for receiving an input signal, a second input for receiving a first local oscillator signal, and an output. The second multiplier has a first input for receiving the input signal, a second input for receiving a second local oscillator signal in quadrature with the first local oscillator signal, and an output. The polyphase filter has first and second inputs respectively coupled to the outputs of the first and second multipliers, and an output for providing an output of the image rejecting mixer. The polyphase filter includes a first filter section, a buffer section, and a second filter section. The first filter section has first and second inputs respectively coupled to the outputs of the first and second multipliers, and an output for providing signals representative of at least two phases of a filtered signal, and has a first passband response. The buffer section has an input coupled to the output of the first filter section, and an output. The second filter section has an input coupled to the output of the buffer section, and an output for providing an output of the polyphase filter, and has a second passband response. The first and second filter sections are configured such that the second passband response compensates for the first passband response.

In yet another form a receiver includes a first mixer, a first filter, a second mixer, and a second filter. The first mixer has an input for receiving an RF signal, and an output for providing an intermediate frequency (IF) signal. The first filter has an input for receiving the IF signal, and an output for providing a filtered IF signal. The second mixer has an input for receiving the filtered IF signal, and an output for providing a baseband signal. The second filter has an input for receiving the baseband signal, and an output for providing a filtered baseband signal. The second mixer may be an image reject mixer as described in the preceding paragraph.

### BRIEF DESCRIPTION OF THE DRAWINGS

The present invention will hereinafter be described in conjunction with the following drawing figures, wherein like numerals denote like elements, and

FIG. 1 illustrates in partial block diagram and partial schematic form a radio receiver having an image rejecting mixer using a polyphase filter according to the present invention;

FIG. 2 illustrates a frequency domain graph of the baseband signal characteristic of the radio receiver of FIG. 1;

FIG. 3 illustrates a block diagram of a portion of the image rejecting mixer of FIG. 1;

FIG. 4 illustrates in schematic form the single-stage polyphase filter of FIG. 3;

FIG. 5 illustrates in schematic form the multiple-stage polyphase filter of FIG. 3;

FIG. 6 illustrates graph of the frequency domain response of the single-stage polyphase filter of FIG. 4;

FIG. 7 illustrates a graph of the pass response of the multiple-stage filter of FIG. 5; and

FIG. 8 illustrates a graph of the reject response of the multiple-stage filter of FIG. 5.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

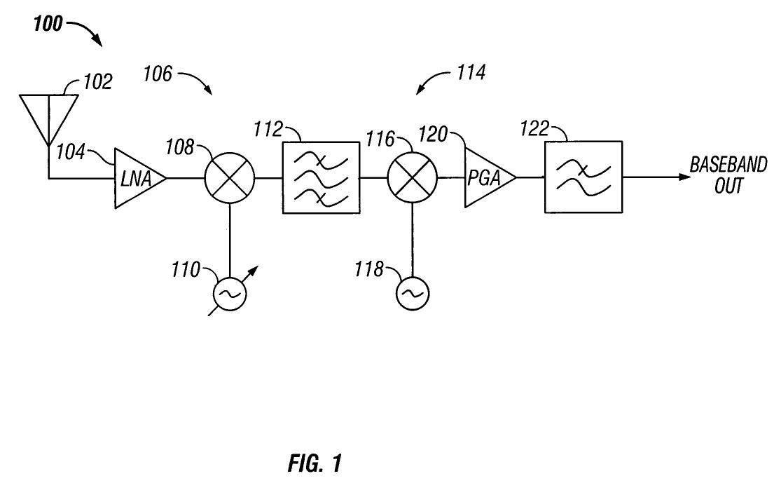

FIG. 1 illustrates in partial block diagram and partial schematic form a radio receiver 100 having an image-rejecting mixer 114 using a polyphase filter according to the present invention. Receiver 100 is a superheterodyne receiver that includes generally an antenna 102, a low noise amplifier labeled “LNA” 104, an RF to IF mixer 106, a bandpass filter 112, image rejecting mixer 114, a programmable gain amplifier labeled “PGA” 120, and a lowpass filter 122. Amplifier 104 has an input terminal connected to antenna 102, and an output terminal, and amplifies a broadband signal received on antenna 102 to provide an amplified signal to the output terminal thereof. Mixer 106 mixes the amplified signal to IF as follows. Mixer 106 includes a multiplier 108 and a tunable oscillator 110. Multiplier 108 has a first input terminal connected to the output terminal of amplifier 104, a second input terminal, and an output terminal. Tunable oscillator 110 has a tuning input terminal and an output terminal that provides an RF local oscillator (LO) signal. The RF LO signal is selected by the tuning input to have a frequency such that a desired channel is mixed from RF to a selected IF, which is also the center frequency of bandpass filter 112. Bandpass filter 112 has an input terminal connected to the output terminal of multiplier 108, and an output terminal for providing an output signal with significant signal energy in a passband centered around the chosen IF, and with significant attenuation of signal energy in a stopband outside the passband.

This signal at the output of bandpass filter 112 is then mixed to baseband in image rejecting mixer 114. Image rejecting mixer 114 includes a multiplier 116 and an oscillator 118. Multiplier 116 has a first input terminal connected to the output terminal of bandpass filter 112, a second input terminal, and an output terminal. Multiplier 114 further includes a polyphase filter for rejecting an image frequency, as will be described more fully below. Oscillator 118 provides an IF LO signal at an output terminal thereof. The IF LO signal is selected to have an output frequency chosen to mix the selected IF signal to baseband, and multiplier 116 thus provides the output signal thereof at baseband. Amplifier 120 is provided to amplify this signal to a desired level, and has an input terminal connected to the output terminal of multiplier 116, and an output terminal. Filter 122 has an input terminal connected to the output terminal of amplifier 120, and an output terminal for providing an output signal of receiver 100 labeled “BASEBAND OUT”.

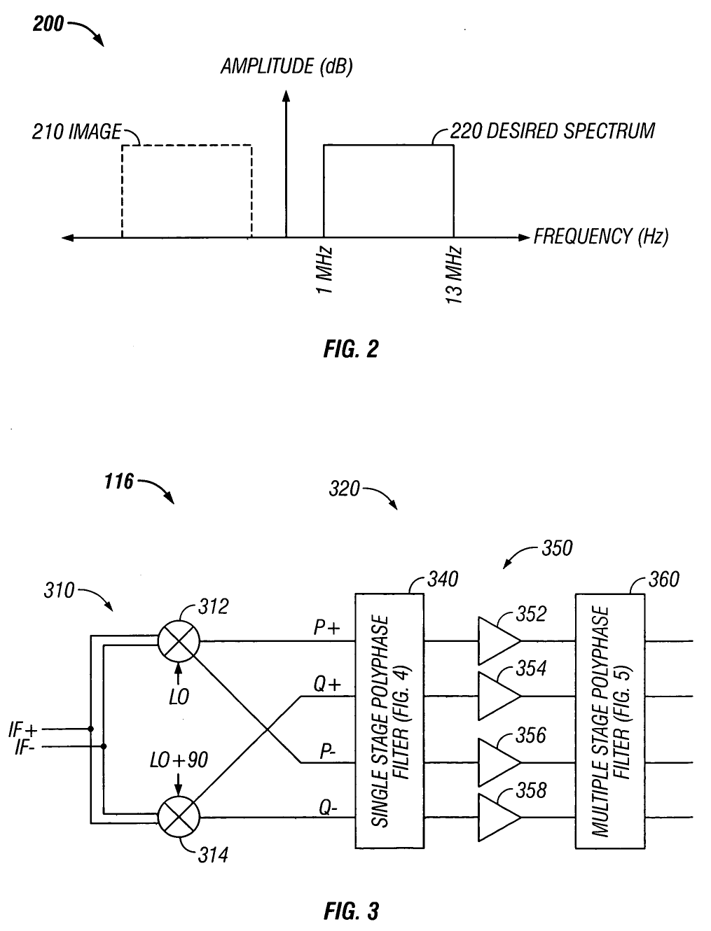

Receiver 100 is a superheterodyne receiver which has a special image rejecting mixer 114 according to the present invention. As is well understood the mixing process causes sum and difference frequencies of the wanted signal to be generated. In many radio environments lowpass filter 122 would be sufficient to filter out adjacent channel energy that would tend to get mixed into the passband. However some radio environments make this single filter insufficient to eliminate unwanted signals mixed into the passband. For example a satellite radio system uses a carrier frequency of 2.3 gigahertz (GHz) and has a desired baseband spectrum as shown in FIG. 2, which illustrates a frequency domain graph 200 of the baseband signal characteristic of radio receiver 100 of FIG. 1. Graph 200 shows that the desired satellite radio spectrum exists from about 1 megahertz (MHz) to about 13 MHz. This spectrum has an image frequency from about −1 MHz to about —13 MHz. This image spectrum may contain other adjacent signals having significant signal power and thereby aliases significant interfering signal energy into the passband. In this environment it is desirable to filter out the image spectrum to attenuate interfering signal energy sufficiently to provide high signal-to-noise ratio of the wanted signal in the passband. Mixer 116 does this image rejection function using a polyphase filter as will be described more fully below.

FIG. 3 illustrates a block diagram of a portion of image rejecting mixer 116 of FIG. 1. This portion includes generally a multiplier section 310 and a polyphase filter 320. Differential signaling is used in the actual implementation of receiver 100, and the output of bandpass filter 112 is represented as a differential signal having a positive component labeled “IF+” and a negative component labeled “IF−”. Multiplier section 310 includes multipliers 312 and 314. Multiplier 312 has a positive input terminal for receiving signal IF+, a negative input terminal for receiving IF−, an oscillator input terminal for receiving an in-phase local oscillator signal from oscillator 118 labeled “LO”, a positive output terminal for providing a positive in-phase output signal labeled “P+”, and a negative output terminal for providing a negative in-phase output signal labeled “P−”. Multiplier 314 has a positive input terminal for receiving signal IF+, a negative input terminal for receiving IF−, an oscillator input terminal for receiving a quadrature local oscillator signal from oscillator 118 labeled “LO+90”, a positive output terminal for providing a positive quadrature output signal labeled “Q+”, and a negative output terminal for providing a negative in-phase output signal labeled “Q−”.

Polyphase filter 320 includes a first filter section in the form of a single stage polyphase filter 340, a buffer section 350, and a second filter section in the form of a multiple stage polyphase filter 360. As used herein, a filter section includes one or more cascaded filter stages. Single stage polyphase filter 340 has an input in the form of four input terminals for receiving signals P+, P−, Q+, and Q− from multipliers 312 and 314, and an output in the form of four corresponding filtered output terminals.

Buffer section 350 includes four buffers 352, 354, 356, and 358. Buffer 352 has an input terminal connected to the P+ output terminal of signal stage polyphase filter 340, and an output terminal. Buffer 354 has an input terminal connected to the P− output terminal of signal stage polyphase filter 340, and an output terminal. Buffer 356 has an input terminal connected to the Q+ output terminal of signal stage polyphase filter 340, and an output terminal. Buffer 358 has an input terminal connected to the Q− output terminal of signal stage polyphase filter 340, and an output terminal.

Multiple stage polyphase filter 360 has an input including input terminals respectively connected to the output terminals of each of buffers 352, 354, 356, and 458, and an output including four output terminals for providing positive and negative in-phase signals and positive and negative filtered quadrature signals. Multiple stage polyphase filter 360 includes an input in the form of four input terminals respectively receiving signals P+, P−, Q+, and Q− from multipliers 312 and 314, and an output in the form of four corresponding output terminals.

The inventor has discovered that a polyphase filter can be made efficiently and have sufficient pass and attenuation characteristics by separating the sections of the filter into one section having at least one polyphase filter stage (such as the illustrated single-stage section) and one section having at least two polyphase filter stages. The order is not important for the filter's frequency response and in other embodiments sections 340 and 360 could be swapped. However when used in image rejecting mixer 114, placing the single-stage polyphase filter section first is desirable because it reduces the loading seen by multipliers 312 and 314.

Since buffers are required between the two passive filter sections, combining one section having at least one stage and one multiple-stage section requires only one set of buffers, saving circuit area. In addition components in multiple stage section 360 can be chosen to shape the image rejection characteristics to filter out an image spanning more than one decade in frequency. These characteristics will be described further with respect to FIGS. 3-8 below.

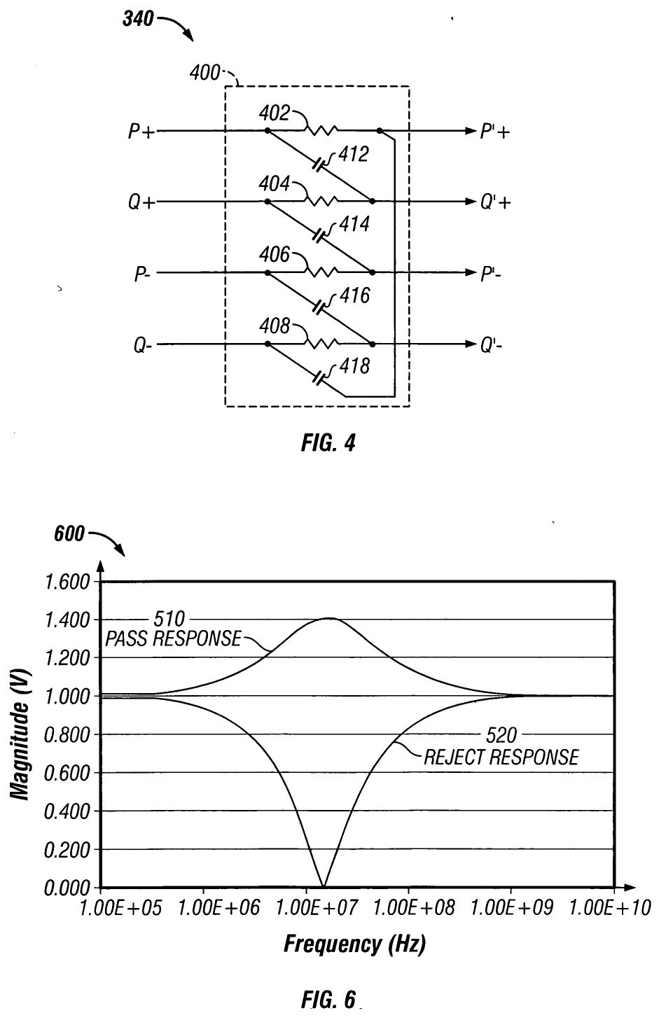

FIG. 4 illustrates in schematic form single-stage polyphase filter 340 of FIG. 3. Filter 340 includes a modular passive filter section 400 including resistors 402, 404, 406, and 408, and capacitors 412, 414, 416, and 418. Resistor 402 has a first terminal for receiving positive in-phase signal P+, and an output terminal for providing a filtered positive in-phase signal labeled “P′+”. Resistor 404 has a first terminal for receiving negative in-phase signal P−, and an output terminal for providing a filtered negative in-phase signal labeled “P′−”. Resistor 404 has a first terminal for receiving positive quadrature signal Q+, and an output terminal for providing a filtered positive quadrature signal labeled “Q′+”. Resistor 408 has a first terminal for receiving negative quadrature signal Q−, and an output terminal for providing a filtered negative quadrature signal labeled “Q′−”.

Capacitor 412 has a first terminal connected to the first terminal of resistor 402, and a second terminal connected to the second terminal of resistor 404. Capacitor 414 has a first terminal connected to the first terminal of resistor 404, and a second terminal connected to the second terminal of resistor 406. Capacitor 416 has a first terminal connected to the first terminal of resistor 406, and a second terminal connected to the second terminal of resistor 408. Capacitor 418 has a first terminal connected to the first terminal of resistor 408, and a second terminal connected to the second terminal of resistor 402.

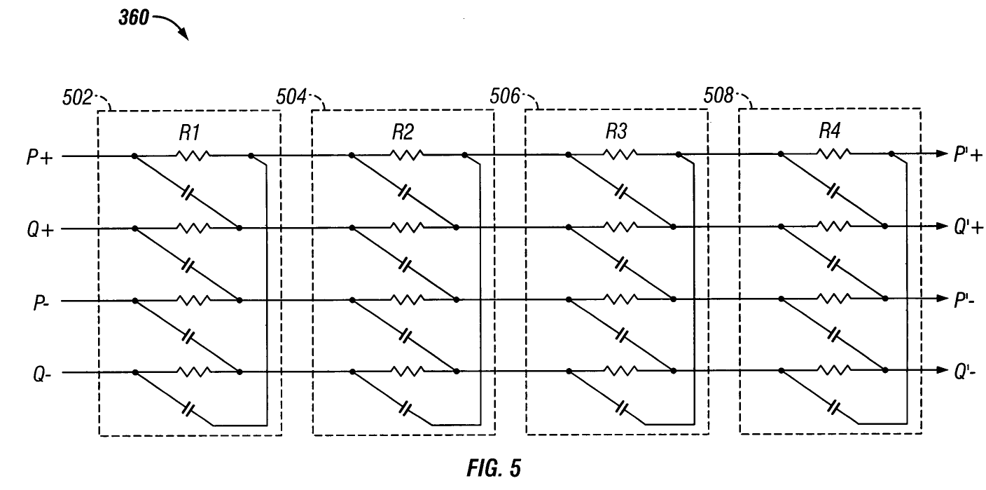

FIG. 5 illustrates in schematic form multiple-stage polyphase filter 360 of FIG. 3. In the illustrated embodiment filter 360 is a four-stage filter including four cascaded filter sections 502, 504, 506, and 508. Each of filter sections 502, 504, 506, and 508 have the same construction as filter section 400 of FIG. 4. Thus using the signal conventions of FIG. 4, the P′+ output of filter section 502 is connected to the P+ input of filter section 504, the Q′− output of filter section 506 is connected to the Q− input of filter section 508, and so on.

The resistors can advantageously be given unequal resistances to form both a desired reject frequency response and a desired pass frequency response. Specifically, if the resistors corresponding to resistor 402 in filter sections 502, 504, 506, and 508 have resistances R₁, R₂, R₃, and R₄, then these resistors can be evenly ratioed to provide desired characteristics. Thus a ratio designated 1:1 represents R₁=R₂=R₃=R₄. Similarly, a ration of 1:2 represents R₂=2¹ R₁, R₃=2² R₁, and R₄=2₃ R₁.

FIG. 6 illustrates a graph 600 of the frequency domain response of single-stage polyphase filter 340 of FIG. 4. Graph 600 has a horizontal axis denoting absolute value of frequency in Hz which is logarithmic in scale, and a vertical axis denoting magnitude in volts which is linear in scale. Graph 600 includes two curves superimposed over each other. A pass response curve 510 corresponding to the upper sideband has a flat characteristic except for a single peak centered around (positive) 13 MHz. A reject response curve 520 corresponding to the image has a flat characteristic except for a single trough centered around (negative) 13 MHz.

What should be readily apparent from the frequency response characteristic shown in FIG. 6 is that a single stage polyphase filter has insufficiently wide attenuation characteristics to reject an image having signal energy covering over a decade in frequency. In addition, the pass response has a peak which could cause significant distortion in signal amplitude for different frequencies in the passband. However the filter section 360 is configured such that its passband response compensates for this peak such that an overall passband response of filter 320 is substantially flat. In the illustrated embodiment the combination of a single stage filter and a multiple stage filter provided by filter 320 compensates for this peak without adding significant circuit area. The placement and size of the passband peak is a function of the number of stages and the relative impedances of the stages in the filter. Each stage loads the previous stage, distorting its passband response. By cascading two or more filter sections (with intervening buffers), each section having one or more stages, it is possible to build filters with flatter passband responses. The passband responses can be tuned by pole placement, as well as by adjusting the impedances of successive stages within a single filter section (described more fully below). Such a polyphase filter can be made to have a passband response that is substantially flat (less than about 0.2 decibels) over the band of interest.

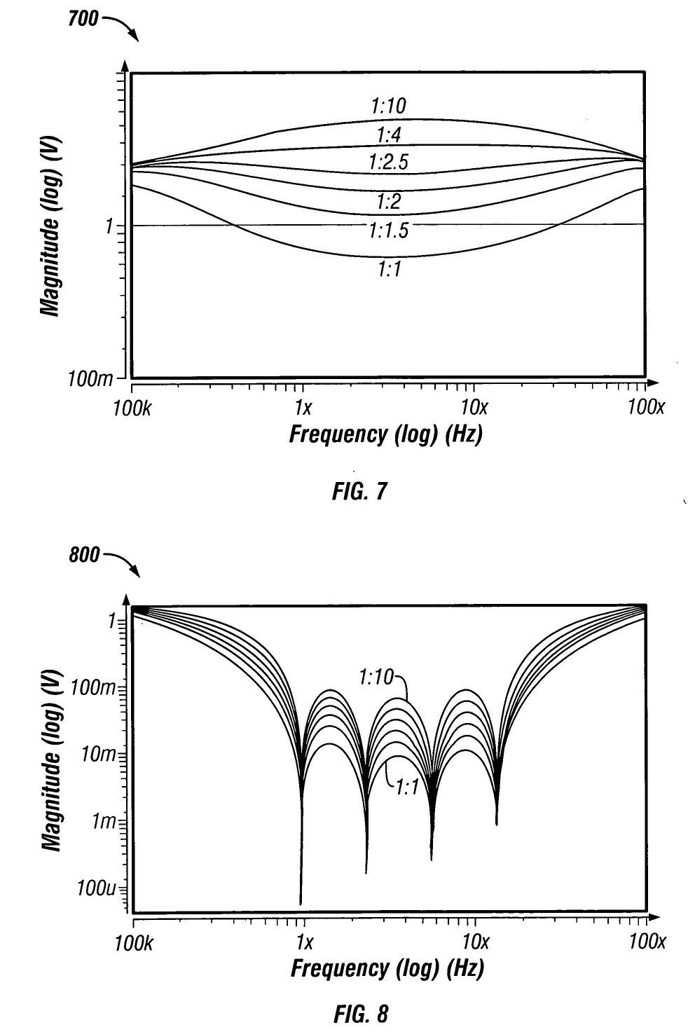

Further to accomplish this purpose the inventor has varied the values of the resistors between each stage in the multiple-stage polyphase filter alter the pass and reject responses such that the ratio can be chosen to provide desired characteristics. FIG. 7 illustrates a graph 700 of the pass response of multiple-stage filter 360 of FIG. 5. Graph 700 has a horizontal axis denoting frequency in Hz which is logarithmic in scale, and a vertical axis denoting magnitude in volts which is also logarithmic in scale. Shown are six curves. These curves correspond to different resistor ratios. The lowermost curve shows a resistor ratio of 1:1. Succeeding curves show resistor ratios of 1:1.5, 1:2, 1:2.5, 1:4, and 1:10. As can be seen, for low resistor ratios, the curve dips around the selected center frequency, whereas for the 1:4 and 1:10 curves spike around the center frequency.

FIG. 8 illustrates a graph 800 of the reject response of multiple-stage filter 360 of FIG. 5. Graph 800 has a horizontal axis denoting frequency in Hz which is logarithmic in scale, and a vertical axis denoting magnitude in volts which is also logarithmic in scale. Shown are six curves for the same resistor ratios as that used in FIG. 7. As can be seen from FIGS. 7 and 8 considered together, it is desirable to select a resistance ratio that causes a slight dip in the pass response (to offset the spike in single-stage polyphase filter 340) while still providing good attenuation in the reject response. Accordingly the inventor has chosen the resistance ratio to be 1:2.5. However it should be apparent that in other receivers operating with other passband and reject band characteristics, a ratio of other than 1:2.5 may be desirable.

Note that in an alternative embodiment, the filter sections could be formed using active filter stages instead of passive filter stages using known active polyphase filter circuits. This alternative embodiment requires operational amplifiers that would increase circuit area and power consumption compared to the passive form of the polyphase filter.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

1. A polyphase filter comprising:
a first filter section having an input for receiving signals representative of at least two phases of an input signal, and an output for providing signals representative of at least two phases of a filtered signal, said first filter section having a first passband response;
a buffer section having an input coupled to said output of said first filter section, and an output; and
a second filter section having an input coupled to said output of said buffer section, and an output for providing an output of the polyphase filter, said second filter section having a second passband response;
wherein said first and second filter sections are configured such that said second passband response compensates for said first passband response.

2. The polyphase filter of claim 1 wherein an overall passband response of the polyphase filter is characterized as being substantially flat.

3. The polyphase filter of claim 1 wherein a first one of said first and second filter sections has at least one polyphase filter stage, and a second one of said first and second filter sections has at least two polyphase filter stages.

4. The polyphase filter of claim 3 wherein said signals representative of at least two phases of said input signal comprise a positive in-phase input signal, a negative in-phase input signal, a positive quadrature input signal, and a negative quadrature input signal, and wherein said signals representative of at least two phases of said filtered signal comprise a positive in-phase filtered signal, a negative in-phase filtered signal, a positive quadrature filtered signal, and a negative quadrature filtered signal.

5. The polyphase filter of claim 4 wherein said first one of said first and second filter sections comprises:
a first resistor having a first terminal for receiving said positive in-phase input signal, and a second terminal for providing said positive in-phase filtered signal;
a second resistor having a first terminal for receiving said positive quadrature input signal, and a second terminal for providing said positive quadrature filtered signal;
a third resistor having a first terminal for receiving said negative in-phase input signal, and a second terminal for providing said negative in-phase filtered signal;
a fourth resistor having a first terminal for receiving said negative quadrature input signal, and a second terminal for providing said negative quadrature filtered signal;
a first capacitor having a first terminal coupled to said first terminal of said first resistor, and a second terminal coupled to said second terminal of said second resistor;
a second capacitor having a first terminal coupled to said first terminal of said second resistor, and a second terminal coupled to said second terminal of said third resistor;
a third capacitor having a first terminal coupled to said first terminal of said third resistor, and a second terminal coupled to said second terminal of said fourth resistor; and
a fourth capacitor having a first terminal coupled to said first terminal of said fourth resistor, and a second terminal coupled to said second terminal of said first resistor.

6. The polyphase filter of claim 4 wherein said buffer section comprises:
a first buffer having an input terminal for receiving said positive in-phase filtered signal, and an output terminal;
a second buffer having an input terminal for receiving said positive quadrature filtered signal, and an output terminal;
a third buffer having an input terminal for receiving said negative in-phase filtered signal, and an output terminal; and
a fourth buffer having an input terminal for receiving said negative quadrature filtered signal, and an output terminal.

7. The polyphase filter of claim 4 wherein said second one of said first and second filter sections comprises a plurality of stages, each stage comprising:
a first resistor having a first terminal for receiving a positive in-phase input signal, and a second terminal for providing a positive in-phase filtered signal;
a second resistor having a first terminal for receiving a positive quadrature input signal, and a second terminal for providing a positive quadrature filtered signal;
a third resistor having a first terminal for receiving a negative in-phase input signal, and a second terminal for providing a negative in-phase filtered signal;
a fourth resistor having a first terminal for receiving a negative quadrature input signal, and a second terminal for providing a negative quadrature filtered signal;
a first capacitor having a first terminal coupled to said first terminal of said first resistor, and a second terminal coupled to said second terminal of said second resistor;
a second capacitor having a first terminal coupled to said first terminal of said second resistor, and a second terminal coupled to said second terminal of said third resistor;
a third capacitor having a first terminal coupled to said first terminal of said third resistor, and a second terminal coupled to said second terminal of said fourth resistor; and
a fourth capacitor having a first terminal coupled to said first terminal of said fourth resistor, and a second terminal coupled to said second terminal of said first resistor.

8. The polyphase filter of claim 7 wherein resistances said first, second, third, and fourth resistors of a first one of said plurality of stages are related to corresponding resistances of said first, second, third, and fourth resistors of a second one of said plurality of stages by a predetermined ratio.

9. The polyphase filter of claim 8 wherein said predetermined ratio is about 1:2.5.

10. A polyphase filter comprising:
at least three polyphase filter stages wherein a first polyphase filter stage has an input for receiving an input signal, and a last polyphase filter stage has an output for providing a filtered signal;
each polyphase filter stage except said first polyphase filter stage having an input coupled to an output of a preceding polyphase filter stage;
each polyphase filter stage except said last polyphase filter stage having an output coupled to an input of a succeeding polyphase filter stage; and
wherein one of said at least three polyphase filter stages is coupled to another one of said at least three polyphase filter stages by means of a buffer.

11. The polyphase filter of claim 10 wherein an overall passband response of the polyphase filter is characterized as being substantially flat.

12. The polyphase filter of claim 10 wherein said first polyphase filter stage is coupled to a second polyphase filter stage by means of said buffer.

13. The polyphase filter of claim 10 wherein a next to last polyphase filter stage is coupled to said last polyphase filter stage by means of said buffer.

14. The polyphase filter of claim 10 wherein said first polyphase filter stage is characterized as being a passive polyphase filter stage.

15. The polyphase filter of claim 14 wherein said first polyphase filter stage comprises:
a first resistor having a first terminal for receiving said positive in-phase input signal, and a second terminal for providing said positive in-phase filtered signal;
a second resistor having a first terminal for receiving said positive quadrature input signal, and a second terminal for providing said positive quadrature filtered signal;
a third resistor having a first terminal for receiving said negative in-phase input signal, and a second terminal for providing said negative in-phase filtered signal;
a fourth resistor having a first terminal for receiving said negative quadrature input signal, and a second terminal for providing said negative quadrature filtered signal;
a first capacitor having a first terminal coupled to said first terminal of said first resistor, and a second terminal coupled to said second terminal of said second resistor;
a second capacitor having a first terminal coupled to said first terminal of said second resistor, and a second terminal coupled to said second terminal of said third resistor;
a third capacitor having a first terminal coupled to said first terminal of said third resistor, and a second terminal coupled to said second terminal of said fourth resistor; and
a fourth capacitor having a first terminal coupled to said first terminal of said fourth resistor, and a second terminal coupled to said second terminal of said first resistor.

16. A method for filtering an input signal to provide a filtered signal comprising the steps of:
forming signals representative of at least two phases of the input signal;
filtering said signals in a polyphase filter having first and second filter sections having respective first and second passband responses, wherein said first section has an input for receiving said signals and an output, and said second section has an input coupled to an output of said first section and an output;
configuring said first and second filter sections such that said second passband response compensates for said first passband response; and
providing said output of said second filter section as the filtered signal.

17. The method of claim 16 wherein said step of configuring comprises the steps of:
forming a first one of said first and second filter sections with at least one stage, and forming a second one of said first and second filter sections with at least two stages.

18. The method of claim 16 wherein said step of filtering comprises the step of buffering said output of said first section to provide said input of said second section.

19. The method of claim 16 wherein said step of forming signals representative of at least two phases of the input signal comprises the step of forming positive and negative in-phase input signals and positive and negative quadrature input signals.

20. The method of claim 16 wherein said step of providing comprises the step of providing positive and negative in-phase filtered signals and positive and negative quadrature filtered signals.

21. An image rejecting mixer comprising:
a first multiplier having a first input for receiving an input signal, a second input for receiving a first local oscillator signal, and an output;
a second multiplier having a first input for receiving said input signal, a second input for receiving a second local oscillator signal in quadrature with said first local oscillator signal, and an output; and
a polyphase filter having first and second inputs respectively coupled to said outputs of said first and second multipliers, and an output for providing an output of the image rejecting mixer, and comprising:
a first filter section having first and second inputs respectively coupled to said outputs of said first and second multipliers, and an output for providing signals representative of at least two phases of a filtered signal, said first filter section having a first passband response;
a buffer section having an input coupled to said output of said first filter section, and an output; and
a second filter section having an input coupled to said output of said buffer section, and an output for providing an output of the polyphase filter, said second filter section having a second passband response;
wherein said first and second filter sections are configured such that said second passband response compensates for said first passband response.

22. The image rejecting mixer of claim 12 wherein an overall passband response of the polyphase filter is characterized as being substantially flat.

23. The image rejecting mixer of claim 21 wherein a first one of said first and second filter sections has at least one polyphase filter stage, and a second one of said first and second filter sections has at least two polyphase filter stages.

24. The image rejecting mixer of claim 23 wherein said first one of said first and second filter sections comprises said first filter section, and said second one of said first and second filter sections comprises said second filter section.

25. The image rejecting mixer of claim 23 wherein said input of said first filter section comprises a positive in-phase input signal, a negative in-phase input signal, a positive quadrature input signal, and a negative quadrature input signal, said output of said first filter section comprises a positive in-phase filtered signal, a negative in-phase filtered signal, a positive quadrature filtered signal, and a negative quadrature filtered signal.

26. The image rejecting mixer of claim 25 wherein said first one of said first and second filter sections comprises:
a first resistor having a first terminal for receiving said positive in-phase input signal, and a second terminal for providing said positive in-phase filtered signal;
a second resistor having a first terminal for receiving said positive quadrature input signal, and a second terminal for providing said positive quadrature filtered signal;
a third resistor having a first terminal for receiving said negative in-phase input signal, and a second terminal for providing said negative in-phase filtered signal;
a fourth resistor having a first terminal for receiving said negative quadrature input signal, and a second terminal for providing said negative quadrature filtered signal;
a first capacitor having a first terminal coupled to said first terminal of said first resistor, and a second terminal coupled to said second terminal of said second resistor;
a second capacitor having a first terminal coupled to said first terminal of said second resistor, and a second terminal coupled to said second terminal of said third resistor;
a third capacitor having a first terminal coupled to said first terminal of said third resistor, and a second terminal coupled to said second terminal of said fourth resistor; and
a fourth capacitor having a first terminal coupled to said first terminal of said fourth resistor, and a second terminal coupled to said second terminal of said first resistor.

27. The image rejecting mixer of claim 25 wherein said buffer section comprises:
a first buffer having an input terminal for receiving said positive in-phase filtered signal, and an output terminal;
a second buffer having an input terminal for receiving said positive quadrature filtered signal, and an output terminal;
a third buffer having an input terminal for receiving said negative in-phase filtered signal, and an output terminal; and
a fourth buffer having an input terminal for receiving said negative quadrature filtered signal, and an output terminal.

28. The image rejecting mixer of claim 25 wherein said second one of said first and second filter sections comprises a plurality of stages, each stage comprising:
a first resistor having a first terminal for receiving a positive in-phase input signal, and a second terminal for providing a positive in-phase filtered signal;
a second resistor having a first terminal for receiving a positive quadrature input signal, and a second terminal for providing a positive quadrature filtered signal;
a third resistor having a first terminal for receiving a negative in-phase input signal, and a second terminal for providing a negative in-phase filtered signal;
a fourth resistor having a first terminal for receiving a negative quadrature input signal, and a second terminal for providing a negative quadrature filtered signal;
a first capacitor having a first terminal coupled to said first terminal of said first resistor, and a second terminal coupled to said second terminal of said second resistor;
a second capacitor having a first terminal coupled to said first terminal of said second resistor, and a second terminal coupled to said second terminal of said third resistor;
a third capacitor having a first terminal coupled to said first terminal of said third resistor, and a second terminal coupled to said second terminal of said fourth resistor; and
a fourth capacitor having a first terminal coupled to said first terminal of said fourth resistor, and a second terminal coupled to said second terminal of said first resistor.

29. The image rejecting mixer of claim 28 wherein resistances of said first, second, third, and fourth resistors of a first one of said plurality of stages are related to corresponding resistances of said first, second, third, and fourth resistors of a second one of said plurality of stages by a predetermined ratio.

30. The image rejecting mixer of claim 29 wherein said predetermined ratio is about 1:2.5.

31. The image rejecting mixer of claim 21 further comprising a local oscillator having a first output for providing said first local oscillator signal, and a second output for providing said second local oscillator signal.

32. The image rejecting mixer of claim 31 wherein said first and second local oscillator signals have a predetermined frequency chosen to mix said input signal to baseband.

33. A receiver comprising:
a first mixer having an input for receiving an RF signal, and an output for providing an intermediate frequency (IF) signal;
a first filter having an input for receiving said IF signal, and an output for providing a filtered IF signal;
a second mixer having an input for receiving said filtered IF signal, and an output for providing a baseband signal; and
a second filter having an input for receiving said baseband signal, and an output for providing a filtered baseband signal;
wherein said second mixer is characterized as being an image rejecting mixer and comprises:
a first multiplier having a first input for receiving said filtered IF signal, a second input for receiving a first local oscillator signal, and an output;
a second multiplier having a first input for receiving said filtered IF signal, a second input for receiving a second local oscillator signal in quadrature with said first local oscillator signal, and an output; and
a polyphase filter having first and second inputs respectively coupled to said outputs of said first and second multipliers, and an output for providing an output of the image rejecting mixer, and comprising:
a first filter section having first and second inputs respectively coupled to said outputs of said first and second multipliers, and an output for providing signals representative of at least two phases of a filtered signal, and having a first passband response;
a buffer section having an input coupled to said output of said first filter section, and an output; and
a second filter section having an input coupled to said output of said buffer section, and an output for providing an output of the polyphase filter, and having a second passband response;
wherein said first and second filter sections are configured such that said second passband response compensates for said first passband response.

34. The receiver of claim 33 wherein an overall passband response of the polyphase filter is characterized as being substantially flat.

35. The receiver of claim 33 wherein a first one of said first and second filter sections has at least one polyphase filter stage, and a second one of said first and second filter sections has at least two polyphase filter stages.

36. The receiver of claim 33 wherein said first mixer mixes said RF signal to a fixed IF.

37. The receiver of claim 33 further comprising a low noise amplifier having an input adapted to be coupled to an antenna, and an output coupled to said input of said first mixer for providing said RF signal.

38. The receiver of claim 33 further comprising a programmable gain amplifier coupled between said output of said second mixer and said input of said second filter.
